(19) United States
(12) Patent Application Publication
(10) Pub. No.: US 2024/0095853 A1
(43) Pub. Date: Mar. 21, 2024

(54) SYSTEM AND METHOD FOR SUPPLIER RISK PREDICTION AND INTERACTIVE RISK MITIGATION IN AUTOMOTIVE MANUFACTURING

(71) Applicants: Honda Research Institute Europe GmbH, Offenbach/Main (DE); HONDA MOTOR CO., LTD., Tokyo (JP)

(72) Inventors: Patricia Wollstadt, Offenbach (DE); May Markusic, Marysville, OH (US); Lydia Fischer, Offenbach (DE); Stefan Menzel, Offenbach (DE)

(73) Assignees: Honda Research Institute Europe GmbH, Offenbach/Main (DE); HONDA MOTOR CO., LTD., Tokyo (JP)

(21) Appl. No.: 17/939,984

(22) Filed: Sep. 8, 2022

(51) Int. Cl. G06Q 50/04; G06N 5/02; G06Q 10/06; G06Q 10/08

(52) U.S. Cl. CPC G06Q 50/04; G06N 5/022; G06Q 10/0635; G06Q 10/0838

(57) ABSTRACT

A method for mitigating effects of a shipment time delay of intermediate products and materials in a manufacturing process comprises, in a training phase, obtaining historical supplier data of the intermediate products and materials, obtaining process parameters of the manufacturing process that are observable for the manufacturing process, and obtaining external data that are independent from the manufacturing process. The method applies a machine learning algorithm to generate a model for predicting a time delay risk in the manufacturing process based on the historical supplier data, the process parameters of the manufacturing process and the external data, and records the generated model in a database. In an application phase, the method obtains current process parameters of the manufacturing process and current external data, and proceeds by predicting an actual time delay risk based on the recorded model for predicting a time delay risk and the current process parameters of the manufacturing process and the current external data. The method generates an output signal including the predicted actual time delay risk, and outputs, via a human machine interface, the generated output signal to a user.

### TECHNICAL FIELD

The subject matter relates to the field of supply chain risk prediction and interactive mitigation of supply chain risk, in particular in the area of automotive manufacturing and of time delay risks of deliveries in the supply chain.

### TECHNICAL BACKGROUND

Manufacturing facilities rely increasingly on delivery of materials and intermediate products just-in-time to the production line and reduce stock of materials and intermediate products to a minimum. Lean management processes are used in order to increase a supply chain's efficiency. As a result, the production becomes vulnerable to any disruption of the supply chain when, for example, a delayed shipment of materials and intermediate products to the manufacturing facility or a supply chain interruption occurs. For example, delays in a range of a few hours or even some minutes may already require the manufacturing process to halt, which in turn increases cost of the manufacturing facility and the production of the final products substantially. Therefore, manufacturing facilities direct significant effort at early detecting and mitigating potential incidents disrupting the manufacturing process such as delays in shipment of materials and intermediate products.

Previously, estimating a supplier's risk of delaying his deliveries in the near future had been based on expert knowledge and the expert's experience with similar situations in the past. This approach is prone to unexpected delayed deliveries and also creates false predictions of delivery delays. Some technical approaches exist to address this issue, however, these approaches fail to exceed the intuitive knowledge provided by a human expert. The human expert, however, is vulnerable to human bias due to the expert user having to model a relationship between risk factors and a target variable by formulating rules or fitting statistical models using his personal experience.

Known approaches in the area of supply chain management focus on reducing risk inherent to the supply chain, for example, by selecting suitable suppliers, modelling a risk propagation through the supply network, optimizing a response to unreliable suppliers, optimizing fleet management, reducing vulnerability to external disruptions. These approaches are suitable in managing static risks. Contrary thereto, the performance of these approaches in identifying dynamic risks in the supply chain, which may result from changes in demand, changes in supplier capability or supplier capacity, or even external events is poor. External events are events external to the manufacturing process, the manufacturing facility and its suppliers. Furthermore, it is desirable to predict supply chain risks several days ahead of the actual shipment delay, opposed to the present capability of identifying risks in the current supply chain structure or in current supply chain data only.

A method and system for the prediction of delays in supplier shipments for a manufacturing process are proposed in order to alert a user of these delays, and to enable the alerted user to take preventative action for mitigating the disadvantages of shortages in materials and intermediate products required for an uninterrupted production process.

### SUMMARY

According to a first aspect, a method for mitigating effects of a shipment time delay of intermediate products and materials in a manufacturing process comprises, in a training phase, obtaining historical supplier data of the intermediate products and materials, obtaining process parameters of the manufacturing process that are observable for the manufacturing process, and obtaining external data that are independent from the manufacturing process. The method applies a machine learning algorithm to generate a model for predicting a time delay risk in the manufacturing process based on the historical supplier data, the process parameters of the manufacturing process and the external data, and records the generated model in a database. In an application phase, the method obtains current process parameters of the manufacturing process and current external data, and proceeds by predicting an actual time delay risk based on the recorded model for predicting a time delay risk and the current process parameters of the manufacturing process and the current external data. The method generates an output signal including the predicted actual time delay risk, and outputs, via a human-machine interface, the generated output signal to a user.

According to a second aspect, a method for mitigating effects of shipment time delay of intermediate products and materials in a manufacturing process, comprises obtaining current process parameters of the manufacturing process and current external data. The current process parameters of the manufacturing process are observable for the manufacturing process, and the current external data are independent from the manufacturing process. The method further obtains a recorded model from a database; and predicts an actual time delay risk based on the recorded model for predicting the time delay risk and the current process parameters of the manufacturing process and the current external data. The method then generates an output signal including the predicted actual time delay risk, and outputs, via a human-machine interface, the generated output signal to a user.

According to a third aspect, a system for mitigating effects of a shipment time delay of intermediate products and materials in a manufacturing process, comprises a user interface, a process data interface for obtaining process parameters of the manufacturing process that are observable for the manufacturing process, and a data interface for obtaining historical supplier data of the intermediate products and materials, and for obtaining external data that are independent from the manufacturing process. The system further comprises a control circuit for applying a machine learning algorithm to generate a model for predicting a time delay risk in the manufacturing process based on the historical supplier data, the process parameters of the manufacturing process and the obtained external data, and for recording the generated model in a database, and the database for storing the generated model. The process data interface is further configured to obtain current process parameters of a current manufacturing process that are observable for the current manufacturing process. The data interface is further configured to obtain current external data that is independent from the current manufacturing process. The control circuit is further configured to predict a time delay risk based on the recorded model for predicting a time delay risk and the obtained current process parameters and the obtained current external data, wherein the user interface is configured to output the predicted time delay risk in an output signal to the user.

### BRIEF DESCRIPTION OF THE DRAWINGS

The attached figures describe embodiments, wherein

FIG. 1 provides a flowchart with an overview of an offline model training and model selecting process;

FIG. 2 provides a flowchart of a data obtaining process for offline model selecting and model training;

FIG. 3 is a flowchart of a model obtaining process obtaining model families and determining hyper parameters for models for the offline model selecting and model training;

FIG. 4 is a flowchart of a model training process during the offline model selecting and model training;

FIG. 5 is a flowchart of a process for calculating a test error as performed during the offline model selecting;

FIG. 6 is a flowchart showing an overview of an online process of predicting a risk using a trained model;

FIG. 7 is a flowchart showing an overview of an online process of evaluating a predicted risk predicted by using a trained model, and using a human-machine interface for deciding whether to mitigate the predicted risk; and

FIG. 8 provides a block diagram presenting an overview of structural units and data flow of a system for supplier risk prediction of an embodiment.

### DETAILED DESCRIPTION

The description of embodiments uses terms as follows:

Risk encompasses production impacts, which include but are not limited to late shipments, production stoppages and repair of units.

The term predictive model denotes an advanced machine learning data analytics model that generates scores indicating a time delay risk in a predetermined future timeframe, such as, for example, the next seven days.

The term training data refers to data used for training the predictive model. The training data utilized is physically generated during a period assumed to involve normal business conditions in a manufacturing process. Training data comprises representations (samples) of input variables and corresponding output variables. The samples of input variables and corresponding output variables are used during model training to determine model parameters that best represent relationship between input variables and output variables of the model.

The term model describes a mathematical model, which represents a data generating process and can be used to describe, for example, the relationship between input data to the data generating process, for example risk factors, and output data generated by the data generating process, for example a risk.

A model parameter is an internal value in a model that determines the representation of the data generating process and the modeled relationship between input variables and output variables. Model parameters are learned by performing model training, in which typically parameters are adjusted in iterations in order to minimize an error of the model on the training data.

A hyperparameter is a parameter that controls the training process of a model and has to be set prior to a training process. Contrary thereto, the model parameter is set or learned during the training process. Values for hyperparameters are determined by repeatedly training on a same training data set with varying hyperparameter values, or hyperparameter sets, to determine which hyperparameter setting results in the best model performance.

A model comprises model parameters, which are determined during a training process called model training. Model training aims at determining model parameters, which best represent (approximate) a relationship between the input variables and output variables of training data. During model training, many instances of the problem to be solved, for example a prediction, are examined. The instances comprise realizations of all input variables and the corresponding instances of the output variables. Algorithms optimize model parameters with the objective of minimizing an error between the predicted output of the model and an actual output of the model based on the available training data. After performing model training, the determined final model parameters are fixed, and the trained model including the final model parameters is stored for a later (off-line) use.

Model selection includes identifying a model having a minimal error on the training data from a set of model families or models with different hyper parameters.

Model operation, or online operation for prediction, refers to using a trained model for predicting based on new input data.

Monitoring comprises evaluating an error that a trained model makes during operation (predicting an event). The error is calculated by storing the generated prediction and comparing it to the actual event that was predicted. Monitoring may also refer to evaluating characteristics of the input data and ensuring those are the same as for the training data used for training the model.

Retraining a model includes repeating the training process on new data, for example, optimizing model parameters of the model in order to best represent the new data.

The term error describes the difference between a model output of the trained model and the corresponding actual output of the process. The actual output may be an output in testing data in off-line training of the model or an output during online prediction using the learned model.

The term accuracy refers to a specific error metric, for example, a percentage of correctly classified instances. In particular, this may include a percentage of instances that were predicted to belong in a particular class and are actually in the particular class.

According to the first aspect, the method for mitigating effects of a shipment time delay of intermediate products and materials in a manufacturing process comprises, in a training phase, obtaining historical supplier data of the intermediate products and materials, obtaining process parameters of the manufacturing process that are observable for the manufacturing process, and obtaining external data that are independent from the manufacturing process. The method applies a machine learning algorithm to generate a model for predicting a time delay risk in the manufacturing process based on the historical supplier data, the process parameters of the manufacturing process and the external data, and records the generated model in a database. In an application phase, the method obtains current process parameters of the manufacturing process and current external data, and proceeds by predicting an actual time delay risk based on the recorded model for predicting a time delay risk and the current process parameters of the manufacturing process and the current external data. The method generates an output signal including the predicted actual time delay risk, and outputs, via a human-machine interface (HMI), the generated output signal to a user allowing the user to react early.

The manufacturing process encompasses a production process at a manufacturing facility or at plural manufacturing facilities that obtains input in the form of intermediate products and material from at least one supplier at delivery time(s), and produces an output in the form of at least one type of final products (end product, part). The end product of this manufacturing process may also be used in a further manufacturing process as an intermediate product.

According to an embodiment of the method, the method includes generating the model by applying a supervised machine learning algorithm for learning risk factors indicative of a future time delay risk from the historical supplier data, the process parameters of the manufacturing process and the obtained external data.

The historical supplier data may include at least one of the process parameters and the external data for a past time.

The process parameters of the manufacturing process may comprise at least one of
a supplier identifier,
a scheduled weekday of target shipment,
a number of planned shipments within a first predefined time period around the target shipment time,
an order volume within a second predefined time period around the target shipment time,
a planned production volume within a third predefined time period around the target shipment time,
a production schedule changes within a third predefined time period around the target shipment time,
a supplier agility in reaction to changes in an order volume,
an identifier of part ordered in the target shipment,
a number of trouble reports on shipments of the target shipment supplier in the past,
a number of partial shipments of the target shipment supplier in the past of the target shipment time,
a delay statistic on shipments of the target shipment supplier in the past of the target shipment time,
a supplier information, and
a capacity system management data of the supplier.
   The external data may include at least one of
a weather event forecast within a sixth predefined time period around the target shipment time,
an occurrence of holiday, school break, bank holiday or seasonal events extracted from a calendar within a seventh predefined time period around the target shipment time,
an occurrence of reported, planned, or predicted shortages extracted from news sites via text mining within a further predefined time period around the target shipment time, and
an occurrence of reported, planned, or predicted strike actions or staffing shortages extracted from news sites via text mining within a further predefined time period around the target shipment time.

The method according to an embodiment comprises predicting the time delay risk including mapping directly the time delay risk to a risk level and using the risk level as a target variable in the step of applying the machine learning algorithm. Alternatively, the method comprises an additional step of assigning the risk level to the predicted time delay in a post-processing step.

The method may include predicting the time delay risk for a time period into the future, wherein a length of the time period depends on the recorded model for predicting a time delay risk, the historical supplier data, the process parameters of the manufacturing process, and the obtained external data.

Generating the model and predicting based on the recorded model of an embodiment of the method uses a supervised machine learning algorithm, at least one of a random forest tree algorithm, a k-nearest-neighbor algorithm, a neural network, a linear model, a support-vector machine, a Gaussian process, a decision tree, and an ensemble method.

According to an embodiment, the method comprises receiving, via a HMI from the user, input data associated with at least one of the historical supplier data and the process parameters of the manufacturing process.

The method according to an embodiment comprises receiving, via a HMI from the user, input data on at least one of model families including a plurality of models, hyperparameters of the plurality of models, parameter ranges of the hyperparameters, and an error metric for generating the model.

According to the second aspect, a method for mitigating effects of shipment time delay of intermediate products and materials in a manufacturing process, comprises obtaining current process parameters of the manufacturing process and current external data. The current process parameters of the manufacturing process are observable for the manufacturing process, and the current external data are independent from the manufacturing process. The method further obtains a recorded model from a database; and predicts an actual time delay risk based on the recorded model for predicting the time delay risk and the current process parameters of the manufacturing process and the current external data. The method then generates an output signal including the predicted actual time delay risk, and outputs, via a HMI, the generated output signal to a user.

The method according to an embodiment may predict the time delay risk for a period of at least one of plural seconds, plural minutes, plural hours, and plural days into the future.

According to an embodiment, the method includes performing the steps of obtaining current process parameters, and predicting the time delay risk online, in particular obtaining the current process parameters in real-time.

The method may include displaying, by the HMI, the predicted time delay risk or a risk level generated by mapping the predicted time delay risk to the risk level.

The method may include displaying, by the HMI, supply shipments in case a risk level of the supply shipments exceeds a predetermined threshold.

The method according to an embodiment comprises displaying, by the HMI, at least one of supply shipments, supplier, supply sources, part types, manufactured products and manufacturing locations with a predicted risk level exceeding a predetermined threshold for the predetermined time period in the future.

The method may include aggregating the predicted risk levels over a predetermined number of supply shipments or over a predetermined time, and displaying, by the HMI, the aggregated predicted risk levels for at least one of supply shipments, supplier, supply sources, part types, manufactured products, and manufacturing locations.

The method according to an embodiment comprises setting, by the user via the HMI, the predetermined number of supply shipments or the predetermined time for aggregating the predicted risk levels.

According to an embodiment, the method includes, at predetermined intervals, repeating steps of obtaining the historical supplier data, obtaining the process parameters of a manufacturing process; and obtaining the external data, applying the machine learning algorithm to generate a retrained model for predicting the time delay risk in the manufacturing process based on the obtained historical supplier data, the process parameters of the manufacturing process and the obtained external data, and of recording the generated retrained model in the database.

The method may comprise monitoring an error that the trained model makes during operation, by comparing an actual event that was predicted with a calculated prediction for the event. In case the monitored error exceeds a threshold, the method may proceed by manually or automatically triggering a step of applying a machine learning algorithm to generate a retrained model for predicting the time delay risk in the manufacturing process based on the obtained historical supplier data, the process parameters of the manufacturing process and the obtained external data.

According to the third aspect, a system for mitigating effects of a shipment time delay of intermediate products and materials in a manufacturing process, comprises a user interface, a process data interface for obtaining process parameters of the manufacturing process that are observable for the manufacturing process, and an external data interface for obtaining historical supplier data of the intermediate products and materials, and for obtaining external data that are independent from the manufacturing process. The system further comprises a control circuit for applying a machine learning algorithm to generate a model for predicting a time delay risk in the manufacturing process based on the historical supplier data, the process parameters of the manufacturing process and the obtained external data, and for recording the generated model in a database, and the database for storing the generated model. The process data interface is further configured to obtain current process parameters of a current manufacturing process that are observable for the current manufacturing process. The external data interface is further configured to obtain current external data that is independent from the current manufacturing process. The control circuit is further configured to predict a time delay risk based on the recorded model for predicting a time delay risk and the obtained current process parameters and the obtained current external data, wherein the user interface is configured to output the predicted time delay risk in an output signal to the user.

The methods and the system use machine learning to learn and model a relationship between input parameters, the internal process parameters and the external parameters on the one hand, and shipment delays as output variables. Internal parameters may comprise, for example, historical behavior of a supplier, planned production volumes of the manufacturing process, number of open shipments among a plurality of other instances of internal parameters. External parameters may comprise data on external events such as extreme weather, shortages in necessary commodities and materials, strikes, holidays, for example, which the method may obtain using data mining techniques such as text mining. During a training phase, for example in an offline process, the method trains the model using records of the historical data in order to generate the trained model. Ranges of time delays may be categorized into risk levels. During the application phase, for example performed as online operation, the trained model is used for predicting delays of future shipments from current input data, using the learned model of how the input parameters relate to predicted time delays for shipment times of intermediate products and material. Predicted time delays may then be mapped to actual risk levels. If the method predicts for a future shipment a delay of a high-risk level, the method may alert a user via a HMI and may highlight the shipment concerned by the predicted time delay and the corresponding supplier in order to enable the user to undertake a suitable preventative action that mitigates the effects of a shortages of the concerned material and intermediate products in the manufacturing process. Preventive actions may include contacting the respective supplier in advance to arrange alternate means of transportation or switching orders in order to avoid a short supply of the materials and intermediate products. Identifying early which shipments are at risk increases a reaction time available to the user, and, in some cases, the resolving actions taken in order to mitigate the short supply situation may require less resources.

The method aspect benefits from recent advances in data mining and machine learning. These algorithms learn a relationship between potential risk factors embodied in the input parameters for the algorithm and an actual risk embodied in the predicted time delays for deliveries of intermediate products and materials from patterns in historical data. The determined relationship is modelled mathematically in order to use it for a prediction of future shipment time delays, as is up to now only implicitly done by human experts. The learning aspect provides a central advantage to the method, because it is more flexible and less vulnerable to human bias than the known approaches of applying expert knowledge.

Moreover, employing machine learning for training the model enables prediction of future shipment time related risks far in advance of actual occurrence of the shipment time delays, a property not known in existing approaches under these circumstances.

The presented method requires no prior and unambiguous knowledge on how process parameters of the manufacturing processes relate to an increased risk for a shipment delay. For example, no specific threshold values for individual process parameters of the manufacturing process indicating a potential risk have to be known a-priori. According to the method, the model learns these dependencies automatically from the historic data. The approach also accounts for potential and even complex interactions between individual predictors. For example, a shipment on a specific weekday may represent a problem if the production volume of the manufacturing process exceeds its usual size.

The solution allows to model an association between input features in the form of internal process parameters and external data and time delay risk from rich and large-scale data sources offline. The modelled association from the training phase is subsequently used in the application phase to predict future time delay risk based on the current state of the input features, in particular the current internal parameters and the external data. The method achieves the object of predicting time delay risk resulting from supplier delays, for example, predicting time delay risk outside the manufacturing facility and using only information directly accessible by the manufacturing facility, in particular internal process parameters of the manufacturing process and information publicly available and external to the manufacturing process. Predicting future time delay risk according to the method may be performed over an extended time horizon, e.g., over several days. The user as a human expert without support of the method will most probably fail in detecting associations through inspection of the underlying input data, which are learned by the model, due to the sheer size of the data set and a complexity of the relationships between input and output of the model. Thus, the method pre-processes the information available and generates and output insight to the user employing a suitable HMI. The user (human operator) is kept in the loop for making decisions on preventative measures in order to mitigate a predicted time delay risk. Thereby, the method supports the user in preventing disruptions in the manufacturing process and increases the rate of prevented disruptions when compared to the rate achieved by the human expert alone and without support of the method.

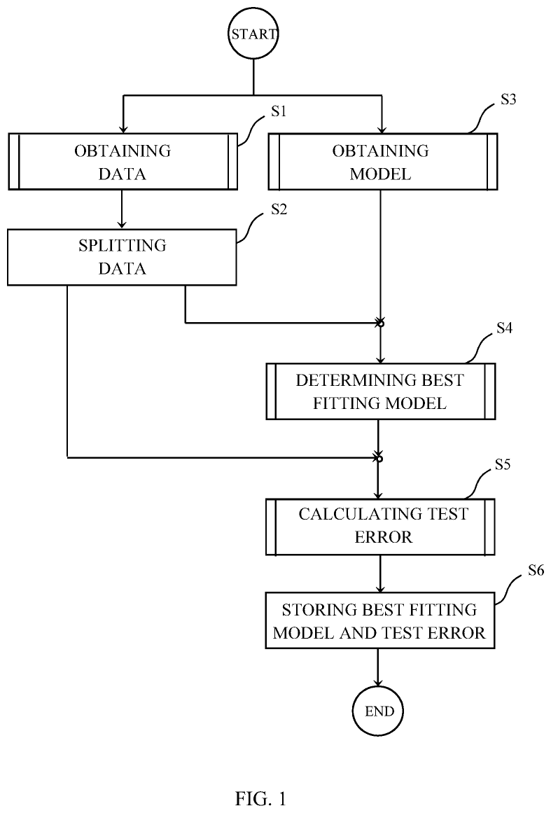

FIG. 1 provides a flowchart with an overview of a model selecting and model training process according to an embodiment. The process steps of FIG. 1 may be performed offline, e.g. in a training phase of the method.

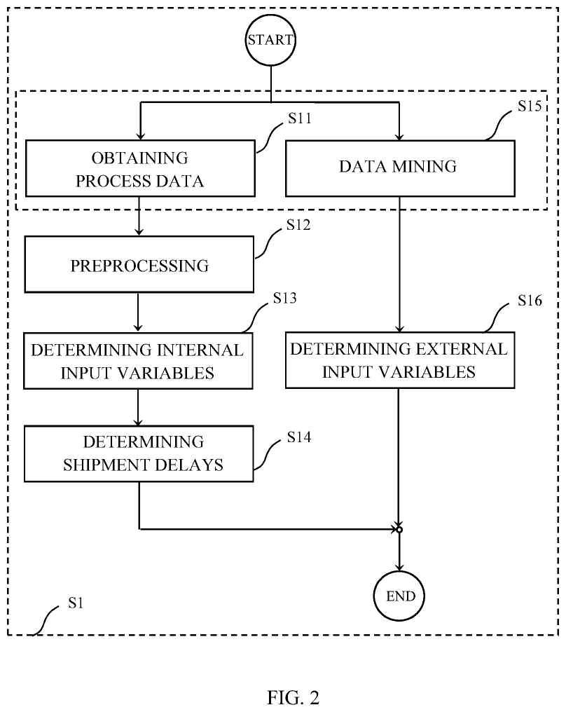

The process starts with a step S1 of obtaining data. The step of obtaining data for the training phase comprises particularly obtaining historical training data from a database and is discussed in more detail with FIG. 2 below.

In step S2, the obtained training data is split into actual training data for training the model and into validation data for validating the model during training.

Furthermore, the obtained training data is split to provide testing data beside the actual training data and validation data. The testing data is used to test a best fitting model determined in a step S4 of determining the best fitting model. Therefore, the testing data is used for evaluating the final trained model later in the process.

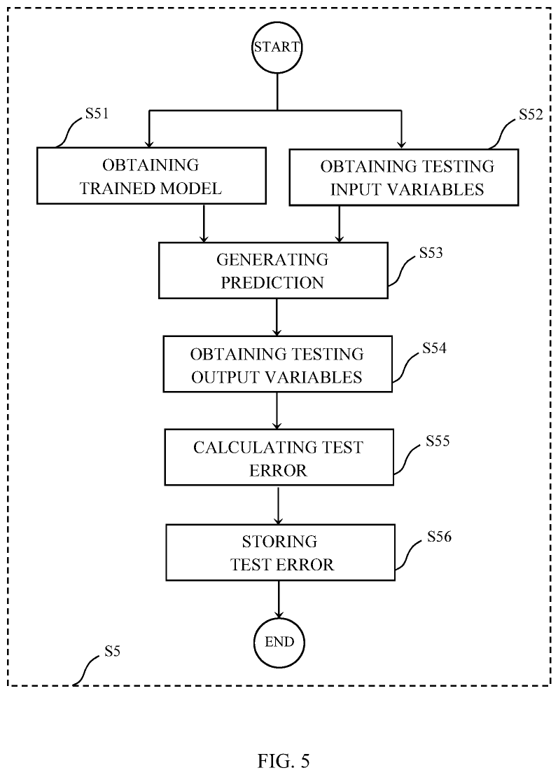

A result of the data splitting step S2 includes a training set of input variables and a training set of output variables for the model fitting using the training data. Further, the data splitting step S2 provides a validation set of input variables and a validation set of output variables for validating a trained model by performing a prediction from the validation set of parameters. Further, the data splitting step S2 provides testing set of input variables and a testing set of output variables for calculating a test error in step S5 and thereby for evaluating the final trained model in step S5, which will be discussed in more detail with reference to FIG. 5.

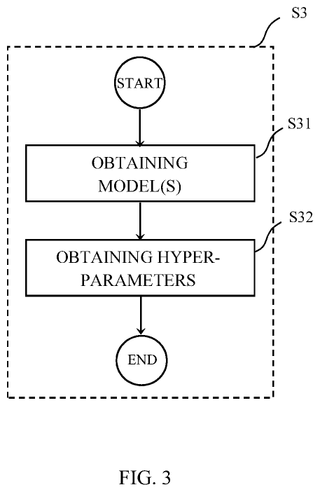

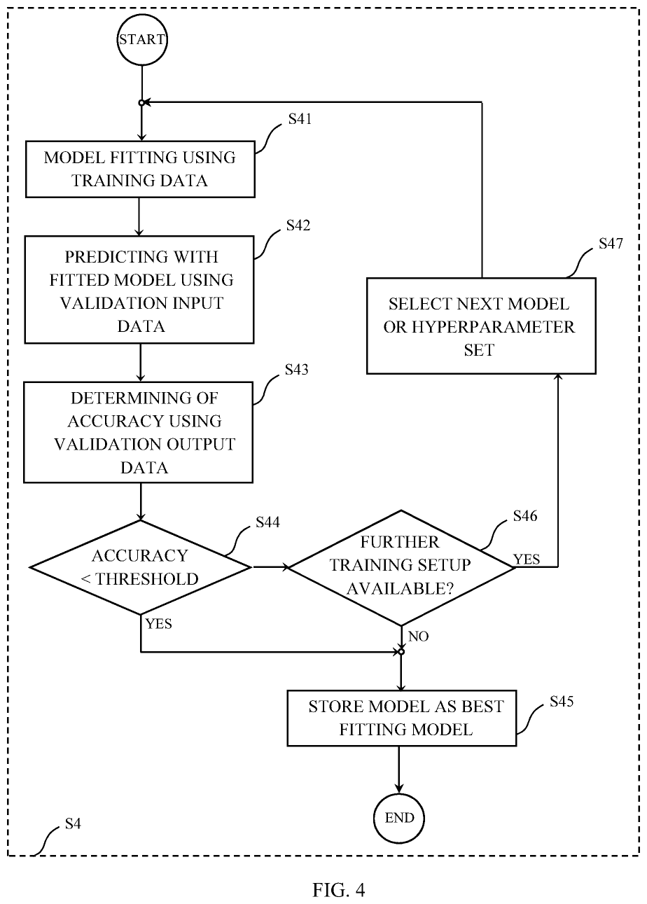

In parallel or sequentially to steps S1 and S2, the method executes a step S3, in which at least one model is selected from the database. The step S3 will be discussed in more detail with respect to FIG. 3. The step S3 obtains the at least one model, which will then form the basis for step S4 of determining the best fitting model based on the training set of input variables (training set input variables) and the training set of output variables training set output variables), and the validation set of input variables and the validation set of output variables provided by the data splitting step S, which will be discussed in FIG. 4.

The step S4 of determining the best fitting model may determine the best fitting model by iterative fitting of model and hyperparameter combinations for each model obtained in step S3 to the set of training data and evaluating the combination with the set of validation data. The evaluation provides the best fitting model, which is subsequently evaluated in step S5 with regard to its performance on unseen data by calculating the test error based on the testing data provided by the data splitting step S2.

In step S6, the best fitting model is stored in the database together with the test error calculated in step S5.

The steps S1 to S5 constitute a training phase of the method, which may be performed offline.

FIG. 2 provides a flowchart of a data obtaining process for offline model selecting and model training. The steps S11 to S16 shown in FIG. 2 define the step S1 of FIG. 1 in more detail.

The data obtaining process includes a step S11 of obtaining internal process data of a manufacturing process. The internal process data of the manufacturing process may be pre-processed in subsequent step S12, and the preprocessed process data is used to determine internal process parameters as input variables for the step S2 of data splitting.

In step S14, the preprocessed process data is used to determine shipment time delays as output variables for the step S2 of data splitting.

Alternatively, the steps S13 and S14 may performed in parallel.

The step S1 of obtaining data further includes a step S15 of data mining to obtain external input data and to determine external input variables from the obtained external input data in step S16.

The determined internal input variables from Step S13, the determined shipment delay times from step S14, and the determined external input variables from step S16 are then provided to the step S2 of data splitting discussed with reference to FIG. 1.

The determined internal input variables, the determined shipment delay times, and the determined external input variables may be stored in the database associated with each other by respective time stamps.

The model incorporates a series of sources of information that can be categorized into internal process parameters and external parameters.

Internal parameters denote information sources directly accessible to the manufacturer, such as information on production and order volume, or historical supplier delay times.

External parameters originate from information sources outside the sphere, e.g. the company, of the manufacturer, for example news sources or weather forecasts. The method obtains external parameters for incorporating into the training phase and the application phase (prediction phase) for the model in order to monitor external influences on the supply chain. The method assumes historical data on the internal parameters and the external parameters as representative of the manufacturing process under normal plant operation and to contain occurrences of shipment delays and high delay risks, and therefore to enable a meaningful model training.

All input variables embody hypotheses on supplier behavior and the dependence of supplier behavior on internal and external factors that have been derived by supply chain experts. Hypotheses include observations such as that high production volumes for specific vehicle models stress the capacities of some suppliers, which leads to short, partial, or late shipments of intermediate products that may be indicative of delaying preventative maintenance in favor of manufacturing capacity or reducing quality control during the manufacturing process. Eventually, using these measures during high-stress phases during the ongoing manufacturing process may lead to occurrence of incidents, for example, a machine breakdown, which in turn leads to delays during the manufacturing process of the supplier or even cause a stop of an entire production line at the supplier's plant, and due to the resulting shipment delays may disrupt the own manufacturing process of the user later. A supplier will not always report his internal issues as long as he is able to provide the shipments of the intermediate products on time, however, existing issues at the supplier's facility may escalate and cause production delays. Hence, indicators of issues such as increasing delays, quality issues, or partial shipments of a particular supplier should be used to identify impending high-risk delays from the supplier. Information not immediately observable for the manufacturer may affect the ability to ship orders for intermediate products in time. This information may include staffing situation at the supplier's plant, shortages of specific components or raw materials, extreme weather events in particular regions or unstable political climate in areas relevant to the supply chain.

A complexity of factors contributing to the timeliness in the supply chain, which potentially interact, results in the advantageous use of machine learning to infer the relationship between the input variables and a future shipment, and in particular a shipment time delay risk associated with the future shipment.

Historical data may include data acquired over a time of a past operation of the manufacturing process. Historical data may also include use of simulated data as input for the training phase of the model, for example, originating from a multi-agent simulation or from digital twins of the supply chain.

In the following sections, a non-exhaustive list of instances of the internal input variables are shortly discussed with the corresponding hypothesis of their relevance for the method.

The internal variables may include a supplier identifier (supplier ID), which unambiguously denotes a particular supplier. Alternatively or additionally, the supplier ID may refer to a group of suppliers.

Some suppliers may generally have an increased risk of delays than other suppliers, independent of other internal or external variables included in the model. The identity of the supplier for a given shipment of intermediate products or material may therefore be predictive of a shipment delay or a delay risk.

The internal variables may include a scheduled day of the week for a shipment. This internal variable may take into account that shipments scheduled for specific days, e.g., for Mondays or for days of the weekend, may be more prone to shipment delays.

The internal variable may include a number of planned shipments during a predetermined time interval including the target shipment time.

The internal variable may include an order volume, e.g., a total number of ordered parts during a predetermined time interval including the target shipment.

Large order volumes may increase stress on the supplier, e.g., resulting in skipping of preventative maintenance or a skipping of quality control, and hence increase the risk of potential shipment delays if the large order volume persists over a given time.

The internal variables may include data on changes in a production schedule or production schedules during a predetermined time interval including the target shipment time. Launches of new products, new or different models of a product, or design changes of a product may affect the capability of the supplier to fulfil its order in time.

The internal variables may include an identifier of a part ordered in a shipment from the supplier.

The internal variables may include a number of trouble reports in the past on shipments by the supplier during a predetermined time interval including the target shipment time.

These internal variables regard that some parts may show an increased risk of shipment delays, for example due to their inherent complexity or a sensitivity to defects. This may apply, for example to intermediate products such as a navigation system, or a sunroof provided by a supplier to the manufacturer of a vehicle.

The internal variables may include supplier information such as at least one of an actual supplier efficiency, an average of hours of overtime (OT) work of the workforce of the supplier, a preventive maintenance completion rate (PM completion rate) of the supplier, a scrap rate incurred during suppler production, an inventory of finished intermediate products (parts) provided by the supplier, a number of outgoing shipments (expedites) of the supplier, a ratio of a contingent workforce to a permanent workforce (contingent-to-perm ratio) for the supplier, an associate turnover, availability/non-availability of associates, recorded data from reporting under the occupational safety and health regulations (OSHA) or workplace safety and insurance (WSIB) regulations.

The internal variables may include a number of partial shipments by the supplier during a predetermined time interval prior to the target shipment time. Additionally or alternatively, the internal parameters may include statistical data on delay in the immediate past of the time of the target shipment. For example, the statistical data comprises an average delay, or a maximum delay observed during a predetermined time interval prior to the target shipment time.

Internal causes in the sphere of the supplier that are independent of changes covered by previously discussed instances of internal parameters may result in problems concerning adherence to delivery dates by the supplier that become observable by their effect of increasing delays in shipments prior to the target shipment.

The internal variables may include capacity management system (CMS) data. The CMS data comprises, for example, supplier equipment efficiency, a number of production lines of the supplier, an output for a predetermined time period, e.g. a daily output, or further capacity related data. CMS data as internal variables takes into regard that the supplier capacity impacts the ability to meet required production volumes for adhering to an agreed delivery schedule. If production volumes exceed a capacity of the supplier, a high risk of shipment delays exists.

The model incorporates external variables in order to monitor external influences not directly related to the supply chain.

The external variables may include forecast(s) of weather events during a predetermined time interval including the target shipment time. In particular extreme weather conditions resulting in flooding, or ice on roads due to low winter temperatures, or heat waves affecting the workforce of the supplier may all influence the ability of the supplier to ship and to provide products in time according to a previously agreed delivery schedule at the manufacturing site.

Additionally or alternatively, the external variables include an occurrence of particular events during a predetermined time interval including the target shipment time. The particular events may be extracted from a calendar using data mining techniques. Such particular events may comprise holidays, events of a regional or national interest, e.g. sporting events, elections.

The external variables may include an occurrence of reported, planned, or predicted of shortages during a predetermined time interval including the target shipment time. The occurrence of shortages may be extracted from online news sites using text mining. Shortages in commodities, e.g. of intermediate products, raw materials, of petrol or even of qualified lorry drivers may result in decreased transport capacity that may affect the ability of the supplier to ship in time, or to provide the parts in time at the site of the user.

The external variables may include an occurrence of of reported, planned, or predicted strikes or staffing shortages staffing qualification issues during a predetermined time interval including the target shipment time. The occurrence of these shortages may be extracted from online news sites using text mining. Problems in in staffing or reduction in work hours due to strike may result in decreased production volume or transport capacity that may affect the ability of the supplier to ship in time, or to provide the parts in time at the site of the user.

FIG. 3 is a simplified flowchart of a model obtaining process according to step S3 of FIG. 1. The model obtaining process includes a step S31 for obtaining model families or at least one model and a step S32 of obtaining (determining) hyperparameters for the obtained model or model families for the model selecting and the model training of the training phase of the method.

Besides historical data, a list of model families and of value ranges for model hyperparameter settings are required by the method for performing model training.

Model families can include models for supervised learning. In particular, the model families may comprise model types such as random-forest tree models, nearest-neighbor approaches, neural networks, linear models, support-vector machines, Gaussian processes, decision trees, or ensemble methods.

For each model type, corresponding model hyperparameters and value ranges for the hyperparameters are obtained in step S32.

Next, we will describe an implementation of the training and model selection process and then the prediction and presentation of the predictions in the GUI.

FIG. 4 is a simplified flowchart of a model training process during the training phase by performing model selecting and model training according to step S4 of FIG. 1 in more detail.

The method identifies the best-performing combination of a model and hyperparameters based on the historical data as the training data by iterative training in the training phase. Training means an iterative adaption of model parameters to the input data such as to minimize a calculated error between a model output and an actual output variable that is part of the training data. A model is identified as the best fitting model based on the training data and returned together as a trained model along with its corresponding test error. Calculating the test error will be discussed with reference to FIG. 5 below. The test error approximates the performance of the trained model when the trained model is applied on novel data, e.g. new instances of the input variables. The test error may enable to judge a model performance during online operation of the method.

Determining the best fitting model starts with a step S41 of model fitting using the training data and thereby generating a current model (fitted model).

The training data comprises training set input variables and training set output variables. The training set input variables comprise internal process parameters and external parameters. The training set output variables comprise respective shipment time delays.

In step S42, the fitted model is validated using the validation data. The validation data includes validation set input variables and validation set output variables. The validation set input variables comprise internal process parameters and external parameters. In particular, the step S42 comprises predicting a time delay based on the validation set input variables using the model fitted based on the training data from step S41.

In step S43, an accuracy of the predicted shipment time delay is determined, for example by calculating a difference to the corresponding validation set output data. The validation set output data comprises a respective shipment time delay corresponding to the validation set input variables of the historical data.

If in step S44 the determined accuracy of step S43 is decided to be below a predetermined threshold, the accuracy of the fitted model is considered to suffice (“YES”), and the method proceeds to step S45.

If in step S44 the determined accuracy of step S43 is decided to be equal or to exceed the predetermined threshold, the accuracy of the fitted model is considered to insufficient (“NO”), and the method proceeds to step S46.

If step S46 the method determines that a further training setup is available (“YES”), the method proceeds to step S47. In step S47, a new model or a new set of hyperparameter values is selected and the method proceeds with step S41 of model fitting using the training data and the selected next model or next hyperparameter set of step S47.

If in step S46 the result is “NO”, meaning there is no further training setup available, the method proceeds to step 45. The result may be determined as “NO”, when it is determined that no further training set including training set input variables and corresponding training set output variables, and no validation set including validation set input variables and corresponding validation set output variables is available.

In step S45, the current trained model is stored in the database as the best fitting model determined based on the training data and the validation data.

For model training, historical data is collected over a period of representative operation of the manufacturing process, e.g., over a period of several months. Pre-processing of the collected historical data is performed, which may also include standard business practices of the manufacturing process that include but are not limited to planned production times and non-production times, specific manufacturing-related events, enterprise-resource planning (ERP) ordering schedule and processes, supplier characteristics, and delivery requirements for intermediate products, materials and manufacturing services.

The obtained historic data are split into training data and test data. The test data is used to train various models of a plurality of models or model families stored in a model database. The model may differ with regard to their hyperparameters. Optimization via a grid search may enable, for example, to arrive at the best model-hyperparameter combination to the respective test data as input data.

The performance of the best-performing model is judged based on an error metric for calculating a test error. The calculated test error may be an overall accuracy determined by comparing predicted time delay errors with actual time delays included in the test data. The error metric used during training is preferably the same error metric as used during testing. The best-performing model is determined based on a training error from the plurality of models, the training error being calculated from the training data. Having identified the best-performing model, the best-performing model is applied to the test data using the same error metric in order to obtain the test error.

FIG. 5 is a flowchart of a process for calculating a test error as performed during the offline model selecting.

The best-performing model is selected based on the test data. The selected best-performing model is then re-trained using the whole training data set and recorded in the database as a trained model.

The recorded trained model may then be used in an application phase by online operation, running the trained model on a server or as a cloud service. The trained model is applied to the test data set to obtain the test error as shown in FIG. 5.

The test error may later be used to monitor model performance in practice and to trigger a retraining if necessary.

FIG. 5 is a flowchart of a process for calculating a test error as performed during the application phase in step S5.

In step S51, the trained model is obtained. In step S52, the testing input variables are obtained.

The process of calculating the test error proceeds with predicting a time delay risk based on the obtained testing input variables and the obtained trained model in step S53.

In step S54, the testing output variables are obtained.

In subsequent step S55, the predicted time delay risk is compared with the obtained testing output variables, and a test error calculated based on the predicted time delay risk and the obtained testing output variables. The calculated test error is stored in step S56 in the database associated with the trained model.

For calculating the test error, a specific error metric is selected: The selected error metric reflects the intended usage of the trained model and may depend on business objectives related to the manufacturing process.

For using the trained model to predict delivery time delays of a supplier, an absolute majority of shipments of intermediate products and materials by the supplier may be on time. To suppress a bias of the trained model towards an artificially high accuracy by always predicting a non-delayed shipment, the error metric has to be chosen appropriately. The method may advantageously use an accuracy on rare, high-risk cases in the historical training data for the training phase and for selecting the best fitting model.

The test error may be used to monitor model performance in the application phase and therefore in the actual application of the trained model and may trigger a re-training of the trained model if decided as necessary.

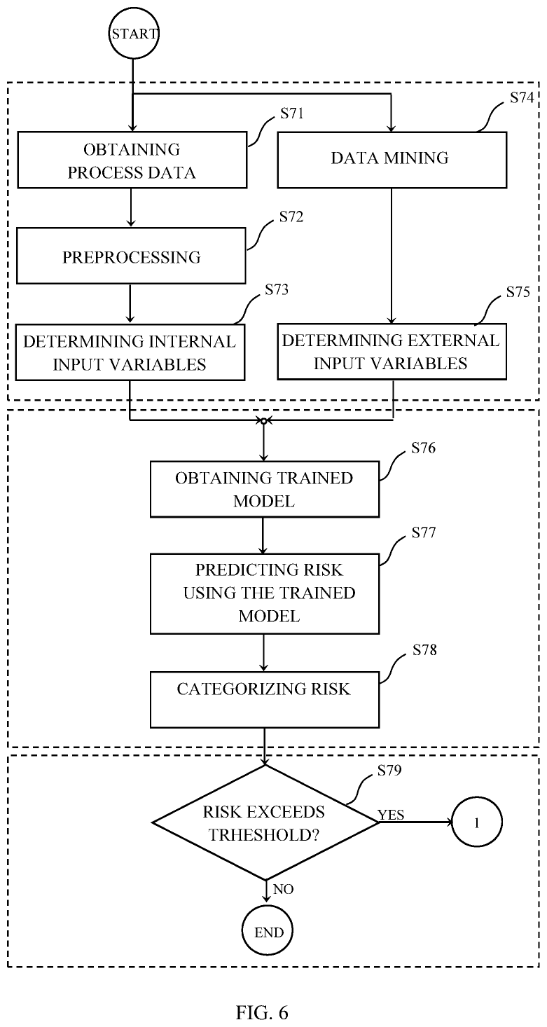

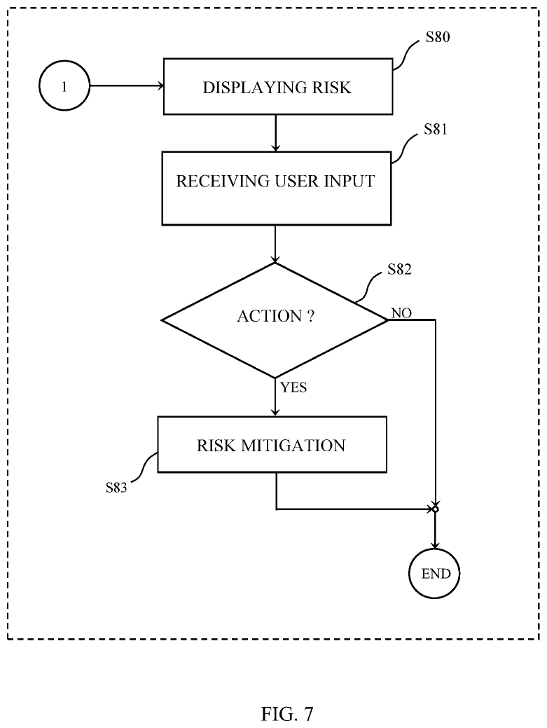

FIG. 6 is a simplified flowchart showing a process of predicting a time delay risk using the trained model in an application phase of the method according to an embodiment. FIG. 7 extends the flowchart of FIG. 6 with respect to a specific user interface (HMI) for taking the user into the decision loop for risk mitigating actions.

New data (current data) generated while the manufacturing process is running, e.g. throughout a production day, will be systematically obtained and stored in the database. The obtained current data includes current internal process data and current external data. The obtained current data is pre-processed in a corresponding manner to the historical data used as training data during the training phase to generate current internal parameters and current external data.

In particular, the application phase includes a step S71 of obtaining current process data. In step S72, the obtained process data is pre-processed and in step S73, current internal input variables are determined from the pre-processed internal process data.

In step S74, data mining is performed to obtain external data. In step S75, the obtained external data is used to determine external input variables.

In step S75, the trained model is obtained from the database.

The steps S71, S72, S73, and steps S74, S75, and step S76 may be performed in parallel or time-sequentially.

Step S77 includes predicting a time delay risk using the obtained trained model and the determined current internal input variables and the determined current external parameters as input data for the trained model. The trained model may be used to predict a time delay. Alternatively or additionally, the trained model may predict a time delay risk level (risk level).

The predicted time delay may be categorized in a subsequent step S78 for categorizing the determined time delay risk into predefined risk levels.

Alternatively, the method may use a trained model, which is trained in the training phase to output a predicted time delay directly categorized into specific risk categories. This particular embodiment may dispense with the step S78 of categorizing the predicted time delay.

The categorized time delay risk from step S78 may then be compared with a predetermined threshold in step S79. If step S79 determines that the categorized time delay risk is equal or smaller than the predetermined threshold in step S79, the process terminates assuming the predicted time delay risk being acceptable and therefore not requiring a risk mitigating action by a user.

If, however, step S79 determines that the categorized time delay risk exceeds the predetermined threshold of step S79, (“YES”), the method proceeds to step S80 of FIG. 7. Given this case, the method determines that the predicted time delay risk requires a mitigating action by a user, or at least providing a suitable alert to the user of the recognized potential time delay risk using the HMI of the system.

The trained model is used to predict production time delays based on the obtained current external parameter and current internal parameter. Predicting the time delay risk can performed for each shipment of intermediate products and material. For each predicted time delay risk, the method may generate a corresponding risk level. Additionally or alternatively, the method may generate a corresponding risk score. A risk score may be generated by normalising the predicted time delay risk. A risk score may be generated by categorizing of the predicted time delay risk. The terms risk level and risk score may be interchangeable in the following discussion.

The method may store the generated predicted risk levels in a database. The database may be a central database the HMI may readily access for referencing and for additional purposes.

Within the HMI, the generated predicted risk levels for all shipments of intermediate products and materials as input to the manufacturing process may be translated, aggregated, and displayed in an intuitive graphical user interface (GUI).

Additional sources of data may be accessed to allow for filtering and aggregation of the predicted time delay and the risk levels derived therefrom, e.g., based on a manufacturing site location, a product type of a product produced in the manufacturing process, or based on a shipped intermediate product.

A software for implementing the GUI may also be served via the computing infrastructure hosting the trained model for online operation. The GUI should provide the functionality described above, such as to enable the user to choose risk mitigation measures according to a geographical location of a manufacturing site associated with a predicted time delay risk, a production item associated with the predicted time delay risk, or a particular shipped intermediate product associated with the predicted time delay risk, for example.

The GUI may include elements enabling the user to initiate risk-mitigation measures in response to an output predicted time delay risk. Measures to mitigate impacts of risks may be pre-formulated and implemented based on various factors, such as manufacturing site location, product type, supplier intermediate products and materials from the supplier, geographical location, known external issues, and known historical issues.

Preventative risk-mitigating actions taken to prevent production impacts may depend on the identified sources or causes of the risky situation.

If lack of manufacturing capacity at the site of the supplier is determined to represent a root cause of predicted time delay risks or declining shipping performance, the risk mitigating action may include sending specialists to engage the suppliers' top leadership on what actions to take to increase capacity.

The risk mitigating action may include installation of additional dyes or tooling, improvement of current equipment efficiency, and modification of existing lines, for example.

If a manpower situation on the supplier's side is determined as declining, staffing specialists are sent to engage a human resources department of the respective supplier to engage in more aggressive recruitment activities, more effective training that will increase engagement or commitment from workers of the supplier.

The risk mitigating action may include, in case quality issues are increasing and resulting in predicted time delay risks for the manufacturing process, sending specialists or engineers for conducting investigations on machines, tooling and equipment, dyes, and whole production lines. These investigations may enable the specialists to provide plans of action on how to reduce the quality issues.

The risk mitigating action may include, in case quality issues are increasing and resulting in predicted time delay risks for the manufacturing process, each manufacturing location may implement sorting procedures to ensure that only intermediate products and materials of sufficient quality are installed in the final products of the manufacturing process.

The risk mitigating action may include, in case the issue is a global shortage of materials resulting in predicted time delay risks for the manufacturing process, implementing an allocation of the materials in short supply based on unique needs of each concerned manufacturing facility, each end product type, and a profitability as a business parameter. For example, for intermediate products common to plural end products, one product type of the end products may have a customer demand, which is larger than another end product type of the end products of the manufacturing process. The risk mitigating action may include reducing production volume of the product type with less customer demand more significantly, or disproportionally compared to the product type with higher customer demand.

The process of predicting a risk may be performed online in order to predict future delays in delivery time of a supplier. The trained model is used to predict future shipment delays based on current input data including current internal parameters and current external parameters, and the relationship between input data and output data, which was learned from the historical data during the training phase.

For predicting the future delay time risk, a prediction horizon may be selected. A prediction can be performed over a predetermined prediction time interval (prediction horizon). The prediction time interval may have a time length of a couple of days, for example one week in a typical manufacturing application of the method.

The prediction horizon may represent a further hyperparameter of the method.

The prediction horizon may be optimized during the training phase of the method.

In the application phase, the method obtains instances of input variables that describe future shipments and maps the predicted time delays to risk levels. Risk levels can be defined as ranges of delays based on requirements applicable for the underlying manufacturing process. In a specific example, predicted time delays with length above 120 minutes represent an upper risk level, predicted time delays from above 15 minutes up to 120 minutes belong to a medium risk level, and predicted time delays up to 15 minutes, therefore all other predicted time delays, are considered to represent no risk or a tolerable risk level.

The method may further implement a monitoring and retraining capability. In order to monitor a performance of the trained model, e.g. during the application phase, the method may compare the performance in terms of the calculated prediction error to the test error calculated during the training phase of the online model and stored associated with the model in the database. To obtain the trained model performance, the method stores predicted time delay risks as well as actually observed time delays as the predicted shipments arrive and compares the stored predicted time delay risks with the actually observed time delays. Whenever the trained model performance deteriorates below a tolerable accuracy, a retraining of the trained model using new training data may be performed.

New training data for retraining the model may comprise training data from more recent times than the training data used in the original training phase of the model.

Retraining of the model may be initiated when the trained model performance falls below a predetermined performance threshold value.

The tolerable accuracy (tolerable margin of error) may be set based on targets of the manufacturing process. The targets of the manufacturing process may include business-related targets.

Monitoring of some properties in the input data, or when preset time intervals elapse may trigger retraining of the trained model, in particular to ensure that retrained model includes the most recent data into the retrained model, or the retraining model is done when the original training data becomes increasingly obsolete.

FIG. 7 is a flowchart showing a simplified overview of an online process of evaluating a predicted risk, which is predicted by using a trained model, and using a HMI for deciding whether to mitigate the predicted risk.

If, in step S79 during the application phase, the method determines that the categorized time delay risk exceeds the predetermined threshold of step S79, (“YES”), the method proceeds to step S80 of FIG. 7. Given this case, the method determines that the predicted time delay risk requires a mitigating action by a user, or at least providing a suitable alert to the user of the recognized potential time delay risk using the HMI of the system.

In step S80, the HMI displays the predicted time delay risk in order to providing an alert to the user communicating the predicted time delay risk to the user by using the HMI of the system.

In step S81, the system receives a user input. In step S82, the method proceeds by determining whether the user input specifies an action in order to mitigate the predicted time delay risk output in the output signal. If step S82 determines that the user input indeed specifies a risk mitigating action (“YES”), the method proceeds to step S83 and executes or supports executing the specified risk mitigating action.

If step S82 determines that the user input does not specify a risk mitigating action (“NO”), the processing terminates.

The method outputs the predicted time delay risk to the user in the output signal via a HMI. The predicted time delay risk may be displayed on a display of the HMI.

For example, shipments with time delays predicted to be of a high or a medium risk level are displayed on the display in order to alert the user of the impending time delay risks in the manufacturing process. The user may then decide to take preventative action to mitigate the predicted time delay risk. Using the HMI to include the user into the decision loop, results in a flexible risk mitigation, and provides the further benefit of compensating a potential wrong prediction of a time delay risk. Outputting the predicted time delay risk via the HMI may enable the user to contact the supplier to verify a predicted time delay risk, before taking other actions, for example terminating a contract or searching for an alternate supply source.

The HMI may comprise the graphical user interface (GUI) to output the output signal including the predicted time delay risk to the user. The GUI may comprise a dashboard and a functionality for further analysing predicted time delay risks in order to enable the user to decide on potential actions for risk-mitigation in the current situation. The functionality may include, but is not limited to filtering, sorting, and aggregating the predicted time delay risk, e.g. in the form of risk levels according to criteria that may include, for example, geographical location or by supplier identity.

Predicted time delay risks can further be enriched by additional information determined based on the input data and a decision taken by the trained model to inform the user about potential reasons for the predicted risk.

A number of functionalities of the HMI may be implemented to improve opportunities for the user to prevent or mitigate risk in time.

The HMI may perform an aggregating of predicted time delay risks. Additionally or alternatively, HMI may perform a filtering of predicted time delay risks for individual shipments by supplier, per geographical location, or other examples of filter or aggregation criteria.

Filtering enables the user to focus on areas of responsibility and therefore supports risk mitigation decisions by the user.

Filter criteria may be, e.g., manufacturing location to enable location leaders to quickly make decisions that will mitigate risks for their specific locations, which include but not limited to changing production plans, sending specialists to the risky suppliers, and negotiating with other manufacturing locations.

Filtering predicted time delay risks based on product types produced in manufacturing processes will enable project managers responsible for specific product types to implement across-the-board countermeasures that will support all manufacturing sites producing said same product types.

Filtering predicted time delay risks based on an individual supplier or supplier intermediate product may enable the user to quickly identify all product types and all manufacturing sites that could be impacted by a risky situation at the individual supplier.

Filtering predicted time delay risks by a particular intermediate product provided by a supplier will assist the user in identifying and determining a precise and effective action to mitigate the predicted time delay risk, for example and to find alternative sources for the particular intermediate product. Quality issues or shortages of certain product types of externally sourced intermediate products can discontinue or disrupt production at a manufacturing site while quality issues or shortages of other product types can be addressed once the affected products are off the production line. The former may require significant production plan changes, higher transport costs, and more manpower resources.

Filtering, in particular sorting predicted time delay risks by the supplier by predicted risk enables the user to identify particular suppliers with a generally high time delay risk or with a high compliance of time schedules.

The HMI may perform an enrichment or supplementing of the predicted time delay risks with additional information.

Supplementing the time delay risk with additional information may include adding historical information on past issues linked to a specific supplier. This allows the user to be more efficient in addressing the predicted time delay risk and in mitigating the anticipated impacts of the predicted time delay risk. A single repository of risk history allows flexibility in shifting manpower movements and decreases risks inherent to a reorganization of manufacturing processes. This applies in particular in the fast-paced environment of the automotive industry.

Supplementing the time delay risk with additional information may include adding geographical information related to the order of the supply shipment. This may enable the user, for example a manager to improve allocation of resources during manufacturing process preparation and to plan for supplier inspection visits. Added geographical information output via the HMI may also indicate if a certain predicted time delay risk is caused by a geographically-driven issues, which may include but is not limited to outbreaks of a disease in an area denoted by the geographical information, inclement weather, political turmoil, public unrest, and union strikes, for example.

Supplementing the time delay risk with additional information may include adding a metric of risk severity, in particular adding a risk severity matrix (matrix of risk severity, risk severity metric) based on business requirements: criteria for a risk severity metric may be pre-determined and agreed upon by all stakeholders of the manufacturing process. The risk severity matrix enables a visualization on whether the predicted time delay risk is acceptable or unacceptable and whether the predicted time delay risk is probable or improbable. The matrix will assist the user as a decision maker in the manufacturing process in prioritizing supplier issues when allocating or reallocating manpower resources.

The user interface, in particular the graphical user interface, may provide a window to the user enabling the user to interact with the GUI. Interacting with the GUI may include providing updates to the system, or uploading files. Information uploaded by the user to the system can be stored in a database associated with a supplier, for example with a supplier ID, and may thus become part of the historical data associated with the supplier. The ability to report updates and to upload information by providing this window as input means of the GUI enables to streamline a reporting process and removes the need for separate communication, possibly over multiple hierarchies in a manufacturing plant. This results in streamlining of reporting and deciding in the manufacturing process and is advantageous in critical situations.

Generated predicted time delay risks and corresponding risk levels of the application phase, together with the corresponding input data to the trained model used for generating the predicted time delay risks may be stored in the database in order to enable an additional analysis of the characteristic aspects of the underlying manufacturing process. The aspects may include technical, organizational, or business-related aspects of the manufacturing process over time.

Performing an additional analysis of the stored predicted time delay risks and corresponding risk levels from the application phase is beneficial to monitor long-term supply chain issues, such as manpower and global supply shortages.

Generated predicted time delay risks and corresponding risk levels may be stored in the database for a predefined period to allow visualization of trends of in a time series of the predicted d time delay risks and corresponding risk levels. Visualizing trends, e.g. an increase, a decrease or a constant trend enables to visualize via the GUI which predicted time delay risks are getting worse and need additional resources, and which time delay risks improve so that allocated resources can be scaled down. Visualizing trends, may also enable to judge effectiveness of actions taken by the user in order to mitigate a predicted time delay risk presented in the output signal to the user.

The GUI may further enable to visualize predicted time delay risks dependent on the corresponding input variable(s) used for the trained model, e.g. dependent on a manufacturing location, or a product type. The GUI provides a risk-management tool for the manufacturing process that may lists the suppliers, the manufacturing location facing the highest risk of production impact, and the product type most affected by a risk-infested situation.

The GUI may provide the user with an overview of a risk landscape faced by the manufacturing company, by a particular manufacturing facility, or by a certain product type produced in the manufacturing process. Multiple users may be enabled by the GUI to view the same business landscape and may arrive at a consensus on actions to take in reaction the predicted time delay risk earlier due to the prediction based on the trained model combining the internal parameters and the external parameters.

Time delay risks caused by singular events not observed in historical data may elapse the prediction using the trained model, which relies in the training phase on the historical data. The system may store such time delay risks in the database when recognizing time delay risks caused by singular events, and may report recognized time delay risks caused by singular events in the GUI.

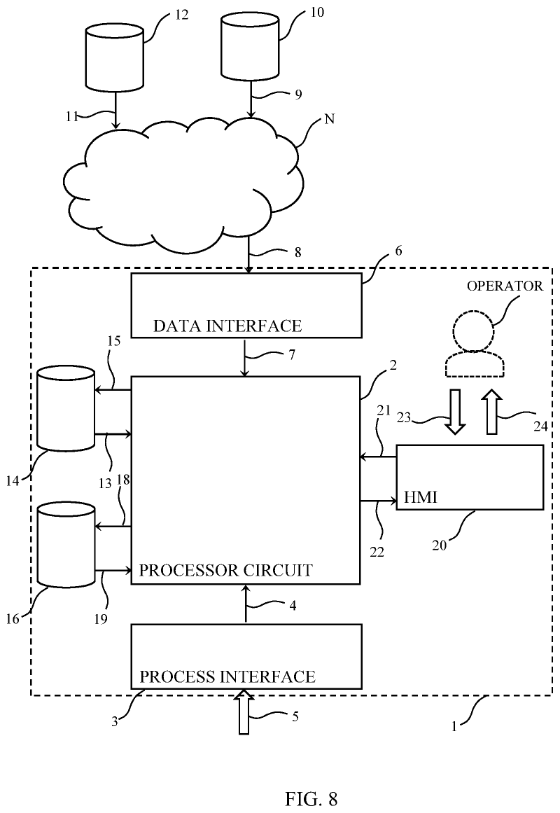

FIG. 8 provides a simplified block diagram presenting an overview of structural units and a data flow of a system for supplier risk prediction according to an embodiment.

The system 1 for mitigating effects of a shipment time delay of intermediate products and materials in a manufacturing process obtains data from both internal data sources and external data sources. External parameters are collected in real-time. Internal parameters are collected with a predetermined frequency.

The system 1 may comprise at least one processing circuit 2 configured to perform the individual processes discussed with reference to FIGS. 1 to 7. The processor circuit 2 may comprise a plurality of microprocessors, signal processors or be implemented by a plurality of servers in a distributed implementation of the system 1.

The system 1 includes a data interface 6 for obtaining historical supplier data 11 of the intermediate products and materials supplied to the manufacturing process from a database 12, and external data 9 that is independent from the manufacturing process from a database 10. The data interface 6 provides the obtained historical supplier data 11 and the obtained external data 19 as historical data and as external parameters 8 to the processor circuit 2.

The database 10 may comprise servers providing weather forecast services and or news services.

The processor circuit 2 may, in particular perform data mining in order to obtain the external data 9 and to generate the external parameters 7 as input variables for the training phase and the application phase. The external data interface 6 is further configured to obtain and provide the control processor 2 current external parameters 7 that are independent from the current manufacturing process.

It is particularly advantageous when the data interface 7 enables the processor circuit 2 to perform data mining over a plurality of data sources 10, for example via a connection to network N of servers, for example a local area network connecting a plurality of databases or via connecting to the world wide web.

The system 1 includes a process data interface 3 for obtaining process data 5 of the manufacturing process that is observable from the manufacturing process.

The process interface 3 provides the obtained process data as internal process parameters 4 to the processor circuit 2. The process data interface 3 is further configured to obtain current process parameters 4 of the current manufacturing process.

The control circuit 2 is configured for applying a machine learning algorithm to generate a model for predicting a time delay risk in the manufacturing process based on the historical supplier data, the process parameters of the manufacturing process and the obtained external data, and for recording the generated model in a database 14.

The database 14 stores the generated trained model 15. The model database 14 further stores model families 13 including models of different model types and hyperparameters of the models.

The processor circuit 2 predicts a time delay risk based on the trained model for predicting a time delay risk and the obtained current process parameters 4 and the obtained current external data 7.

The system 1 further comprises a user interface 20 for outputting the predicted time delay risk 22 in an output signal 24 to the user. The user interface 20 may further acquire a user input 23 and provide the user input 23 to the processor circuit 2 as user input data 21.

The processor circuit 2 may store data 18 including, for example, external data, internal process parameters, hyperparameters of trained models in a database 16 and load the stored data from the database 16.

Internal parameters are generated real-time in an existing Enterprise Resource Planning (ERP) system forming part of a contemporary manufacturing environment or manufacturing facility. The internal process parameters are data that is downloaded regularly, e.g. daily, and stored in the database 16. A regular download of new ERP data ensures that the predicted time delay risks and corresponding risk levels are relevant for the prediction horizon and allows the user to implement measures to mitigate the respective risks for the manufacturing process. Additional internal databases may be used to obtain internal parameters that indicate the suppliers' capacities, planned production volumes, time frames of product life, as discussed above for the internal parameters.

External parameters may be mined from publicly available or proprietary data sources using known methods of data mining, in particular text mining. Publicly available data sources may be news sites, social media platforms, etc., accessible via a local network, or a world-wide network N such as the internet.

Text mining methods, or news feeds, or mining of Twitter feeds may be used to obtain information on trending topics or pre-defined keywords reflecting events associated with a supplier risk. An example for text mining is disclosed in: Song, M., and Kim, M. C. (2013). RT²M: Real-Time Twitter Trend Mining System. 2013 International conference on social intelligence and technology. IEEE, 64-71, which uses a tf-idf approach (term frequency-inverse document frequency). This approach uses a measure that reflects the importance of a term in a document and provides a useful metric for searching for relevant external parameters for the method. Events include but are not limited to weather, union strikes, port delays, and shortages of intermediate products and materials, e.g. semiconductors, steel, chemicals. Furthermore, external data and external parameters may be supplied by business partners, which include but are not limited to the business partners in the supply chain of the manufacturing process, logistic partner providing transportation services and other entities who share information with the manufacturing facility.

Internal and external parameters are obtained (collected) and stored in the database 16 from the application layer, data can be obtained for training or re-training the model in the training phase, or for predicting based on the trained model in the application phase.

The method and system 1 for mitigating effects of a shipment time delay of intermediate products and materials in a manufacturing process provides an advantageous capability to alert early on an increasing risk of time delay in a supply chain due to an advance sensing of increased time delay risk. An innovative use of machine learning and predictive models provides the user with an increased reaction time that enables the user to mitigate production interruptions, and thereby decreases cost of operating a manufacturing site.

Advantageous application areas of the method include logistics operations that depend on and benefit from punctual, on-time delivery of products and materials, from supply chains for manufacturing operations, in particular just-in-time production often encountered in vehicle production, or manufacturing on-demand.

1. A method for mitigating effects of a shipment time delay of intermediate products and materials in a manufacturing process, comprising
obtaining historical supplier data of the intermediate products and materials;
obtaining process parameters of the manufacturing process that are observable for the manufacturing process;
obtaining external data that are independent from the manufacturing process;
applying a machine learning algorithm to generate a model for predicting a time delay risk in the manufacturing process based on the historical supplier data, the process parameters of the manufacturing process and the obtained external data;
recording the generated model in a database;
obtaining current process parameters of the manufacturing process and current external data; and
predicting an actual time delay risk based on the recorded model for predicting a time delay risk and the current process parameters of the manufacturing process and the current external data;
generating an output signal including the predicted actual time delay risk, and
outputting, via a human machine interface, the generated output signal to a user.

2. The method according to claim 1, including
generating the model by applying a supervised machine learning algorithm for learning risk factors indicative of a future time delay risk from the historical supplier data, the process parameters of the manufacturing process and the obtained external data.

3. The method according to claim 1, wherein
the historical supplier data includes at least one of
the process parameters and the external data for a past time,
the process parameters of the manufacturing process include at least one of
a supplier identifier,
a scheduled weekday of target shipment,
a number of planned shipment within a first predefined time period around the target shipment time,
an order volume within a second predefined time period around the target shipment time,
a planned production volume within a third predefined time period around the target shipment time,
a production schedule changes within a third predefined time period around the target shipment time,
a supplier agility in reaction to changes in an order volume,
an identifier of part ordered in the target shipment,
a number of trouble reports on shipments of the target shipment supplier in the past,
a number of partial shipments of the target shipment supplier in the past of the target shipment time,
a delay statistic on shipments of the target shipment supplier in the past of the target shipment time,
a supplier information,
a capacity system management data of the supplier, and
the external data includes at least one of
a weather event forecast within a sixth predefined time period around the target shipment time,
an occurrence of holiday, school break, bank holiday or seasonal events extracted from a calendar within a seventh predefined time period around the target shipment time,
an occurrence of reported, predicted, or announced shortages extracted from a news sites via text mining within an eight predefined time period around the target shipment time,
an occurrence of reported, predicted, or announced strike actions or staffing shortages extracted from a news sites via text mining within an eight predefined time period around the target shipment time, an occurrence of reported, predicted, or announced shortages extracted from the results of a computer-based multi-agent logistics simulation, and
an occurrence of reported, predicted, or announced shortages extracted from the results of a computer-based manufacturing simulation.

4. The method according to claim 1, wherein
predicting the time delay risk comprises mapping directly the time delay to a risk level and using the risk level as a target variable in the step of applying the machine learning algorithm, or
the method further comprises a step of assigning the risk level to the predicted time delay in a post-processing step.

5. The method according to claim 1, including
predicting the time delay risk for a time period into the future,
wherein a length of the time period depends on the recorded model for predicting a time delay risk, the historical supplier data, the process parameters of the manufacturing process, and the obtained external data.

6. The method according to claim 1, wherein
generating the model and predicting based on the recorded model uses a supervised machine learning algorithm or at least one of a random forest tree algorithm, a k-nearest-neighbor algorithm, a neural network, a linear model, a support-vector machine, a Gaussian process, a decision tree, and an ensemble method.

7. The method according to claim 1, including
receiving, via a human machine interface from the user, input data associated with at least one of the historical supplier data and the process parameters of the manufacturing process.

8. The method according to claim 1, including
receiving, via a human machine interface from the user, input data on at least one of model families including a plurality of models, hyper parameters of the plurality of models, parameter ranges of the hyper parameters, and an error metric for generating the model.

9. A method for mitigating effects of shipment time delay of intermediate products and materials in a manufacturing process, comprising
obtaining current process parameters of the manufacturing process and current external data,
wherein the current process parameters of the manufacturing process are observable for the manufacturing process, and the current external data are independent from the manufacturing process;
obtaining a recorded model from a database; and
predicting an actual time delay risk based on the recorded model for predicting the time delay risk and the current process parameters of the manufacturing process and the current external data;
generating an output signal including the predicted actual time delay risk, and
outputting, via a human machine interface, the generated output signal to a user.

10. The method according to claim 9, wherein
predicting the time delay risk for a period of at least one of plural seconds, plural minutes, plural hours, and plural days into the future.

11. The method according to claim 9, including performing the steps of
obtaining current process parameters, and predicting the time delay risk online, in particular obtaining the current process parameters in real-time.

12. The method according to claim 9, including
displaying, by the human machine interface, the predicted time delay or a risk level generated by mapping the predicted time delay to the risk level.

13. The method according to claim 9, including
displaying, by the human machine interface, supply shipments with a predicted risk level exceeding a predetermined threshold.

14. The method according to claim 9, including
displaying, by the human machine interface, at least one of supply shipments, supplier, supply sources, part types, manufactured products and manufacturing locations with a predicted risk level exceeding a predetermined threshold for the predetermined time period in the future.

15. The method according to claim 9, including
aggregating the predicted risk levels over a predetermined number of supply shipments or over a predetermined time,
displaying, by the human machine interface, the aggregated predicted risk levels for at least one of supply shipments, supply sources, part types, manufactured products and manufacturing locations.

16. The method according to claim 15, including
setting, by the user via the human machine interface, the predetermined number of supply shipments or the predetermined time for aggregating the predicted risk levels.

17. The method according to claim 9, including at predetermined intervals repeating
obtaining the historical supplier data;
obtaining the process parameters of a manufacturing process;
obtaining the external data;
applying a machine learning algorithm to generate a retrained model for predicting the time delay risk in the manufacturing process based on the obtained historical supplier data, the process parameters of the manufacturing process and the obtained external data;
recording the generated retrained model in the database.

18. The method according to claim 9, wherein
the method comprises monitoring an error that the trained model makes during operation, by comparing an actual event that was predicted with a calculated prediction for the event, and
in case the monitored error exceeds a threshold, manually or automatically triggering a step of
applying a machine learning algorithm to generate a retrained model for predicting the time delay risk in the manufacturing process based on the obtained historical supplier data, the process parameters of the manufacturing process and the obtained external data.

19. A system for mitigating effects of a shipment time delay of intermediate products and materials in a manufacturing process, comprising
a user interface;
a process data interface for obtaining process parameters of the manufacturing process that are observable for the manufacturing process;
an external data interface for obtaining historical supplier data of the intermediate products and materials, and external data that is independent from the manufacturing process;
a control circuit for applying a machine learning algorithm to generate a model for predicting a time delay risk in the manufacturing process based on the historical supplier data, the process parameters of the manufacturing process and the obtained external data, and for recording the generated model in a database; and
the database for storing the generated model;
the process data interface is further configured to obtain current process parameters of a current manufacturing process that are observable for the current manufacturing process;
the external data interface is further configured to obtain current external data that is independent from the current manufacturing process;
the control circuit is further configured to predict a time delay risk based on the recorded model for predicting a time delay risk and the obtained current process parameters and the obtained current external data; and
the user interface is configured to output the predicted time delay risk in an output signal to the user.
